(19) United States
(12) Patent Application Publication
(10) Pub. No.: US 2011/0132922 A1
(43) Pub. Date: Jun. 9, 2011

(54) BEVERAGE DISPENSING SYSTEM, APPARATUS, AND/OR METHOD

(76) Inventors: Jeffery Summers, Woodland Hills, CA (US); Cody Summers, Woodland Hills, CA (US)

(21) Appl. No.: 12/581,874

(22) Filed: Oct. 19, 2009

Related U.S. Application Data
(63) Continuation-in-part of application No. 11/060,935, filed on Feb. 18, 2005.
(60) Provisional application No. 61/106,558, filed on Oct. 17, 2008.

(51) Int. Cl. A47G 19/22; B67D 7/58

(52) U.S. Cl. 222/1; 220/705; 222/207; 222/211

(57) ABSTRACT

Apparatuses are disclosed for a small group to drink a potable liquid, such as an alcoholic beverage, or other beverage. A container preferably made of glass, metal, and/or ceramic material, and having an aperture, is provided to accommodate the potable liquid. A substance with a selected temperature is added to the container. A prefilled canister of potable liquid can then be inserted through the aperture so that the canister comes in contact with the first substance, whereby the selected temperature of the substance is allowed to influence the temperature of the canister, and thus the temperature of the potable liquid as well. A dispenser assembly with one or more hoses, pumps, and mouthpieces are also provided. Each such hose, pump, and mouthpiece facilitates a corresponding consumer in consuming the potable liquid. In a preferred embodiment, the pump dispenses a predetermined volume of the beverage to the consumer in a controlled unidirectional flow.

### RELATED APPLICATIONS

This application is a non-provisional of, and claims priority from, U.S. Provisional Patent Application No. 61/106,558, filed Oct. 17, 2008, and is a continuation-in-part of, and claims priority from, co-pending U.S. patent application Ser. No. 11/060,935, filed Feb. 18, 2005, both of which are hereby incorporated by reference in their entirety.

© 2009 Jeffery Summers and Cody Summers. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d), (e).

### TECHNICAL FIELD

This application pertains to systems, apparatuses, and/or methods for dispensing potable liquids, and more particularly, to dispensing potable liquids for consumption by a multiple individuals in a group setting.

### BACKGROUND OF THE INVENTION

Containers for storing and pouring liquids for consumption, especially water, date back near the beginning of civilization. A myriad of sizes, shapes, and varieties are known. In modern times, all sorts of beverages, e.g. water, juice, beer, coffee drinks, etc. are packaged and sold in various containers, often made of aluminum, polymeric materials (plastics) or glass. Removable lids, “pop tops,” and such are known for opening the container to enable pouring a liquid from the container into a drinking vessel or directly into the mouth of the consumer. Sometimes consumers use a drinking straw to withdraw liquid from a container. All of these methods and apparatuses pertain to one individual drinking from a container, which is an essentially personal, individual activity. That said, it is well known of course for people to gather in homes, bars, and other venues to engage in social intercourse while drinking, especially while drinking alcoholic beverages, but each person drinks from his own container.

A very different but socially important tradition of the Middle East is the art of hookah smoking. The hookah, also referred to as a narghile or narghila, sheesha, hubble-bubble, or water-pipe, has long inspired great discussions of politics, religion, and the daily events. In social gatherings, a hookah with a single hose is sometimes used. A narghile is placed in the center of a group and, after puffing on the mouthpiece, smokers pass the hose around to the next person in the circle, generally chatting all the while in a friendly, cordial atmosphere. Often, a hookah is used that has multiple hoses, say three or four, so that each smoker has his own mouthpiece, and passing it around is unnecessary.

The popularity of the hookah has increased dramatically in recent years, mainly due to the social nature of hookah smoking. In the United States, where life is frenetic, it certainly contributes to the smoker's integration in his or her social environment in a brotherly peaceful act of solidarity. Smoking, however, is now known to present serious health risks to the user, and to those around her. Smoking has recently been banned in many public places such as shops, restaurants and buses in the United States and abroad.

In an attempt to provide a more socially engaging opportunity to consume beverages in a group setting, many bars or similar venues have begun offering “bottle service,” where by a group of consumers typically purchases some pre-established minimum number of bottles of beverage and sits around a table to enjoy the beverages. Unfortunately, bottle service has many disadvantages. Among those is most notably that it results in a crowded table and often a messy area. The table is usually filled with multiple bottles, several glasses, large amounts of ice, any of which can easily be knocked over. The individual consumers are responsible for mixing their own drinks, which often results in improper flavor and diluted drinks as ice melts. Further, most of these items also require frequent tending by servers at the venue (e.g., refilling ice, cleaning spills, bringing new glasses, etc.), which strains the venue's resources.

The need remains for systems, apparatuses, and/or methods that facilitate and encourage relaxed social gatherings and, in particular, that enable small group social activities such as imbibing.

### SUMMARY

Consistent with the present application, systems, apparatuses, and/or methods are disclosed for enabling a small group of consumers comfortably and enjoyably to drink a potable liquid, such as an alcoholic beverage, or other beverage. In one embodiment, a container (which can be made of glass, metal, ceramic, or another material) is provided. The container includes an aperture. A substance with a selected temperature is added to the container. A prefilled canister of potable liquid can then be inserted through the aperture so that the canister comes in contact with the first substance, whereby the selected temperature of the substance is allowed to influence the temperature of the canister, and thus the temperature of the potable liquid as well. A dispenser assembly with one or more hoses, pumps, and mouthpieces are also provided. Each such hose, pump, and mouthpiece facilitates a corresponding consumer in consuming the potable liquid. In a preferred embodiment, the pump dispenses a predetermined volume of the beverage to the consumer in a controlled unidirectional flow. Because the potable liquid can be maintained within a sealed canister and the liquid does not mix with the substance of selected temperature in the container, preferred embodiments consistent with the present invention can offer a potable liquid having a substantially consistent temperature and flavor balance, even over prolonged periods of consumption.

Additional aspects and advantages will be apparent from the following detailed description of preferred embodiments, which proceeds with reference to the accompanying drawings.

### BRIEF DESCRIPTION OF THE DRAWINGS

FIG. 1 is a perspective view of an apparatus for consumption of a liquid in accordance with a first embodiment of the present invention.

FIG. 2A illustrates a stopper and hoses in another embodiment of the invention.

FIG. 2B is a partially sectional view of a distal end portion of a hose showing an internal check valve and one mouthpiece embodiment.

FIG. 3A is a perspective view illustrating actuation of a pump to discharge liquid through one mouthpiece embodiment in accordance with another aspect of the invention.

FIG. 3B illustrates refilling the pump by releasing it to its inherent shape.

FIG. 3C is a perspective view showing use of a hose and associated pump embodiment to discharge a predetermined shot of liquid into the mouth of a consumer.

FIG. 4A is an enlarged, partially cross-sectional view showing detail of a pump embodiment and a mouthpiece one-way valve embodiment.

FIG. 4B illustrates a user squeezing the pump embodiment of FIG. 4A to discharge its fluid contents out of the mouthpiece.

FIG. 5 illustrates another embodiment of a stopper and hoses in accordance with the invention, including a smooth, hollow, rigid liner disposed in each hose aperture.

FIG. 6 illustrates an exploded view of components of an alternative beverage dispensing system embodiment consistent with the present invention.

FIGS. 7A & 7B illustrate another alternative embodiment of a system as disclosed herein, illustrated in partially assembled and disassembled views respectively.

FIG. 8 illustrates a cutaway view of a partially assembled the system of FIG. 7A, illustrated with one hose embodiment.

FIG. 9 presents the uncut system embodiment of FIG. 8.

FIG. 10 illustrates a cutaway view of a pump assembly embodiment consistent the present application.

FIG. 11 illustrates the cutaway pump assembly embodiment of FIG. 10 with a removable mouthpiece embodiment removed.

FIGS. 12-14 present cutaway views illustrating alternative embodiments of lids for canisters consistent with the present application.

FIGS. 15 & 16 illustrate a portion of one embodiment of a container consistent with the present invention, shown in exploded and cutaway views respectively.

FIGS. 17 & 18 illustrate a portion of another embodiment of a container consistent with the present invention, shown in exploded and cutaway views respectively.

FIGS. 19 & 20 illustrate alternative a pump assembly embodiment in side and perspective view respectively.

FIGS. 21-23 illustrate the pump assembly embodiment of FIGS. 19 & 20 in various exploded view configurations.

FIG. 24 illustrates the pump assembly embodiment of FIGS. 19 & 20 in an assembled, cut-away view.

### DETAILED DESCRIPTION OF PREFERRED EMBODIMENTS

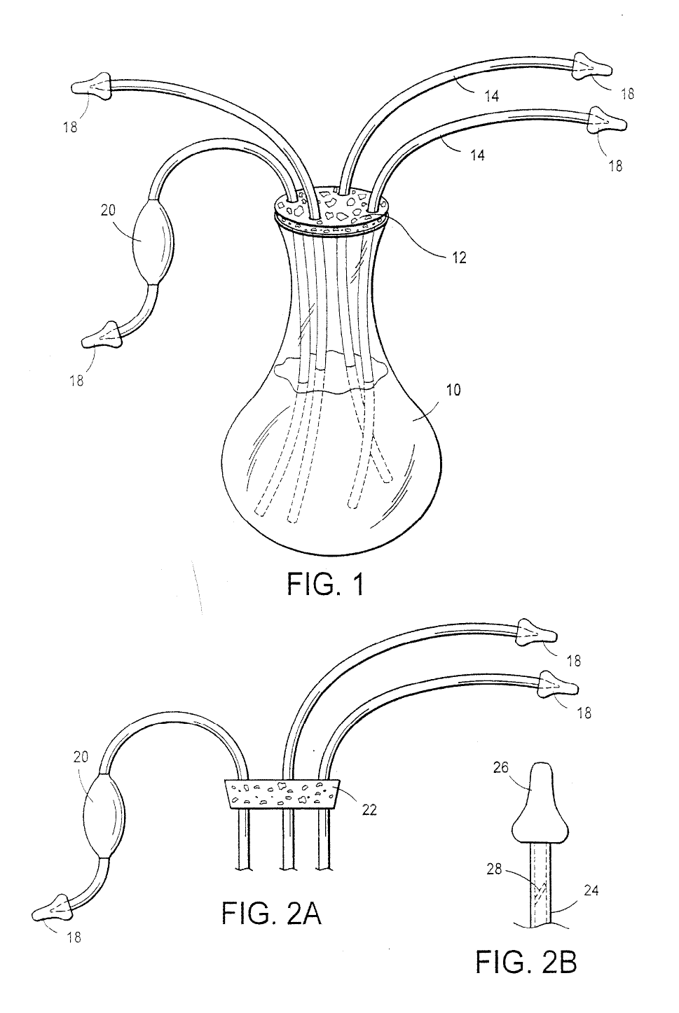

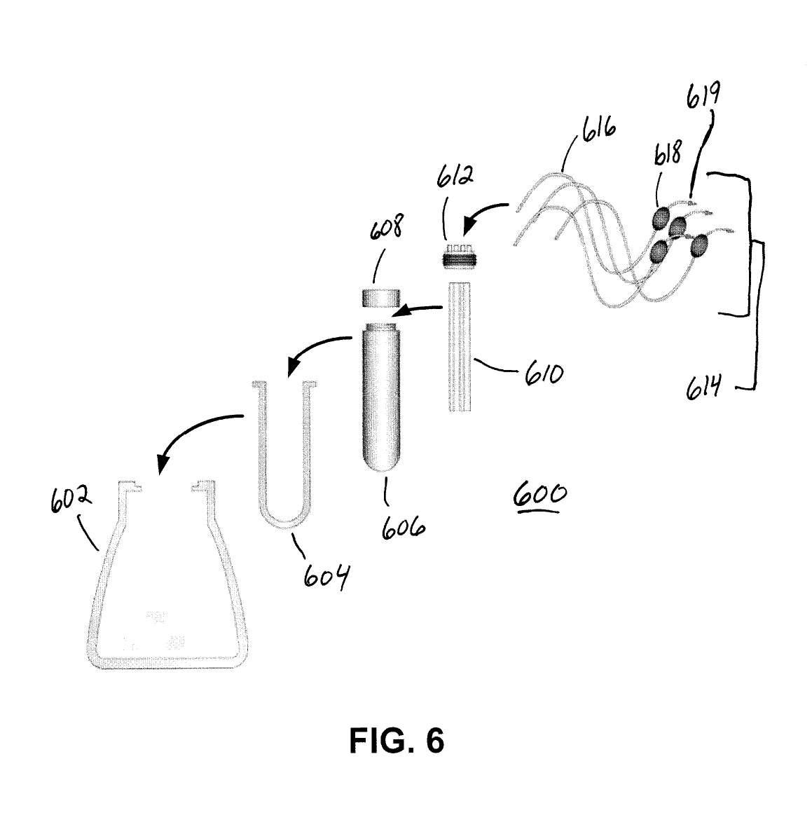

With respect to the following disclosure, FIGS. 1 through 5 illustrate a simplified first system embodiment and individual container, pump, mouthpiece, hose, and stopper embodiments under the present application. FIG. 6 and on illustrate more presently preferred additional and alternative embodiments under present application.

Continuing with reference to the simplified embedment of FIG. 1, FIG. 1 presents a perspective view of an embodiment of a beverage dispensing system in accordance with the present invention. The beverage dispenser is designed to enable a plurality of persons to drink a beverage from a common container. It can be used by one person, or by more than one person. Where more than one person are using the container, each of them can drink from it concurrently, meaning that each of them takes a sip of beverage from the container, from time to time, during the same general time frame. They can also drink from it simultaneously, i.e., where all of the users take a drink from the common container at exactly the same time.

In the illustrated embodiment of FIG. 1, the container 10 is made of glass or any other water impermeable rigid or semi-rigid material. Glass or ceramic materials are preferred. The container may or may not be transparent, and can be adorned with decorative surface ornamentation (not shown). Any potable liquid can be dispensed using the container 10, such as water, juice, wine, etc., to name a few.

The container can be filled and sealed prior to shipment and sale, for example by a beverage manufacturer, bottler, or wholesaler. It can then be resold at retail to consumers in a market, bar, restaurant, kiosk, sporting venue, etc. Preferably, the container would be sold together with the associated stopper(s), hoses and such as described herein. Alternatively, a user could purchase an empty container and the related apparatus as described herein and fill it himself with a selected beverage. Among other things, the invention is useful for a small group of adults to share an alcoholic beverage. However initially obtained, the container preferably is washable and reusable, although it can also be disposable.

In one embodiment, container 10 is fitted with a stopper 12, made of cork, rubber or other suitable material for sealing the beverage within the container 10 to avoid spilling. For reasons explained later, even if the container is knocked over from the upright position shown, little or no beverage will escape. The stopper 12 includes a plurality of holes extending through it to accommodate dispenser hoses, through which the beverage is to be dispensed to the users. (Where a filled container moves through commerce prior to use, it will of course be sealed initially, for example with a stopper or the like that has no holes.) In one embodiment, each hole in the stopper 12 is sized to fit a single hose 14. Each hose 14 is made of a flexible, water impermeable material such as rubber tubing. Both the stopper 12 and the hoses 14 preferably are made of a cleanable, reusable material. In this way, after the beverage is consumed, the container 10 and related paraphernalia can be cleaned and then reused.

As illustrated in FIG. 1, a plurality of hoses 14 can extend through corresponding holes in the stopper 12. In one embodiment, the container 10 can have a volume on the order of one or two liters although the particular volume is not critical. It could be sized to hold several liters in which case the number of hoses might be increased to accommodate a larger number of users, on the order of eight or ten. Smaller versions of the container might be outfitted with just two or three hoses. The particular number of hoses is not critical.

In any event, the hoses preferably have a length to make it convenient for users who are gathered around the container to partake of the beverage through the users respective hose. Each user preferably assigned her own hose for hygienic purposes. Thus, for example, each hose might have a length on the order of 12 to 36 inches, although the length is not critical. In the presently described embodiment, each tube has an inside diameter of approximately 5/16's of an inch. The distal end of each hose preferably is fitted with a mouth piece 18 described further below. We refer to the distal end of the hose as the opposite end of that which is inside the container 10 during use.

In another embodiment, the hose is bisected into two parts. A first part extends generally from the stopper down into the container. A second part, disposed entirely outside the container, extends from the stopper to the distal (mouthpiece) end. The first and second parts are in fluid communication with one another within or adjacent the stopper so that fluid from the container can flow through the first part of the hose and into the second part of the hose toward the user.

In another embodiment, an “extension hose” can be provided to effectively lengthen either a unitary or a two-part primary hose. When an extension hose is fitted to the distal end of the primary hose, the mouthpiece is relocated to the distal end of the extension hose. In other embodiments, a mouthpiece can be integrally formed with a hose or extension hose.

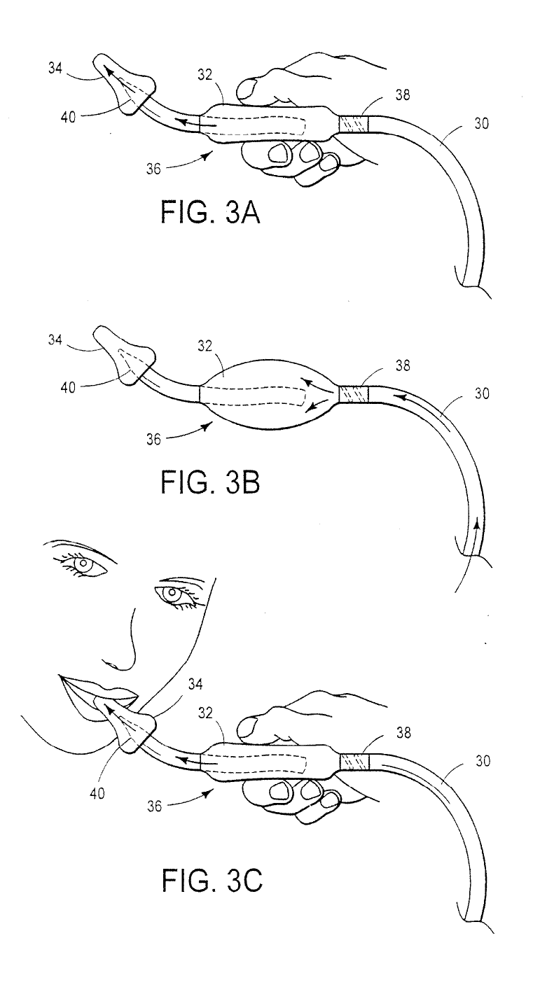

Referring again to FIG. 1, one or more of the hoses can be outfitted with a pump 20. The function of the pump 20 is to dispense a predetermined volume of beverage, for example a “shot” through the tube and into the mouth of a user. A “shot” is a commonly known measure for alcoholic beverages on the order of one-and-one-half fluid ounces. The shot pump 20 is described in further detail below with reference to FIGS. 2 and 3. As shown in FIG. 1, the shot pump is installed along a hose generally adjacent to the distal end although the spacing from the distal end is not critical.

FIG. 2A shows a stopper 22 having three holes through it for accommodating hoses. As noted, the stopper can be formed to accommodate any desired number of users; preferably it would have between two and eight such holes and corresponding hoses. In this embodiment, one of the hoses has a pump.

FIG. 2B is a cross-sectional view of the distal end region of a typical hose. In FIG. 2B, the hose 24 has a mouthpiece 26 installed on a distal end thereof and further includes an internal flange or check valve 28. In one embodiment, the flange is arranged to prevent backwash of beverage into the container 10 during use. The flange allows fluid flow in one direction only; namely, toward the distal end of the hose 24.

FIG. 3A is a cross-sectional view of a distal portion of a hose 30. In this example, a shot pump 32 is provided for dispensing a predetermined volume of beverage out of the mouthpiece 34. The volume so dispensed is determined by the volume of the bulbous region 36 of the shot pump 32. The mouthpiece 34, which may be cleanable and/or disposable, includes an interior flange also known as a check valve 40 which will allow fluids (both air and liquid) to flow in one direction only; again, toward the user. In initial operation, a user squeezes the bulbous region 36 to a compressed condition, thereby forcing the air out of the volume of the bulbous region 36 of the shot pump 32. The hose check valve 38 prevents the air from traveling down the hose toward the container. Accordingly, the air is forced through the check valve 40 and out through the mouthpiece 34.

Then, the user releases the bulb 36 which, because of the resiliency of the bulb material, allows it to return to its original size and shape, as illustrated in FIG. 3B. The resiliency of the bulb, and the laws of physics, causes it to pull fluid into the bulb to fill the space as it expands to its original shape. The check valve 40 prevents fluid (air or liquid) from flowing into the bulb through the mouthpiece 34. However, the flange 38 permits the flow of fluid out of the beverage container 10 and into the bulb 36 as shown in FIG. 3B. Accordingly, an amount of beverage flows into the bulb approximately corresponding to the volume of the bulb. One might say that the shot pump is now refilled or “loaded.”

Referring next to FIG. 3C, when ready, a user holds the mouthpiece 34 in her mouth and then she (or an assistant) squeezes the bulb, thereby discharging the volume of beverage held in the bulb 36 into her mouth via mouthpiece 34. As noted, other users may be consuming beverage from the same container 10 at the same time and, one or more of them may be using a shot pump in like fashion.

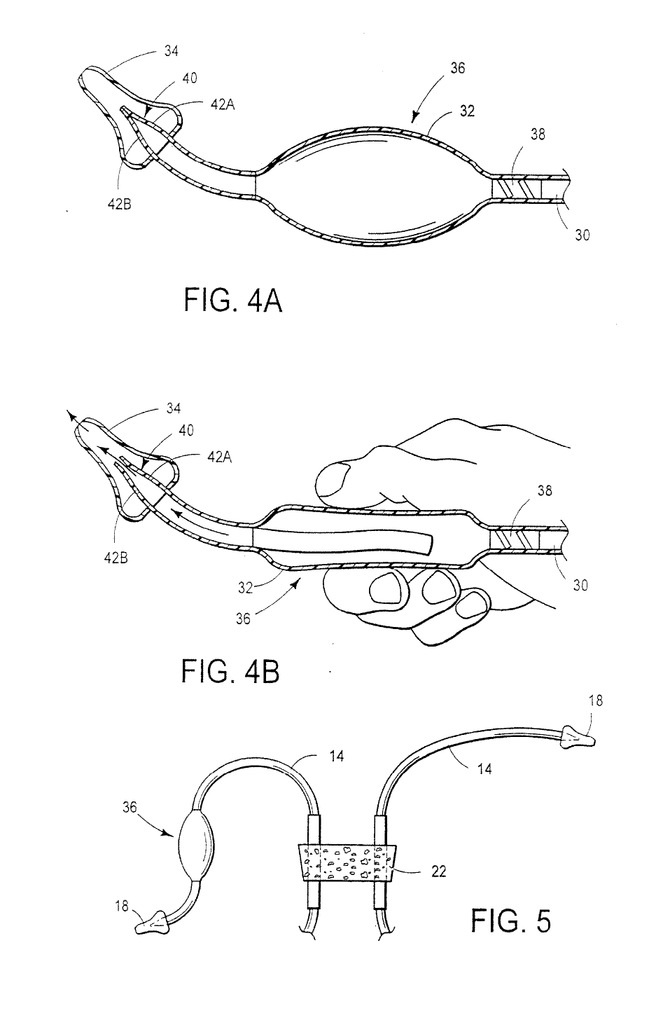

FIG. 4A is an enlarged, partially cut away view showing detail of the check valve 40 inside of the mouthpiece 34. The check valve in one embodiment is formed of an opposed pair of flaps 42A and 42B which are impermeable to fluids, but nonetheless flexible and resilient. Accordingly, in use, when a fluid is pulled through the hose toward the mouthpiece, either by suction applied by the user or due to squeezing the shot pump, or both, the opposed flaps of the check valve will separate allowing the fluid to flow there through, as shown in FIG. 4B. On the other hand, any fluid flow in the direction toward the container will cause the resilient flaps to come together thereby sealing of the distal end of the hose to prevent such fluid flow. Thus, the reader will appreciate that the subject beverage dispenser can be used at home, in a bar, in a restaurant, or in another location where people engage in social interaction that includes drinking beverages.

In one embodiment, the beverage container 10 (see, FIG. 1) can be made of glass and can have a distinctive shape and/or surface ornamentation or coloring, so that it when empty, it can be carried away as souvenir. FIG. 5 illustrates another embodiment of a stopper and two hoses in accordance with the invention, including a smooth, hollow, rigid liner disposed in each hose aperture to facilitate insertion of the hose. The liner can extend outside the stopper, as illustrated, or it can be sized flush with the top and bottom surfaces of the stopper. The hoses can be sized to fit over the liner, above and below the stopper, in which case the hose is bisected. Alternatively, the hose can fit into and through the liner, as shown.

Consistent with the present invention, one or more alternative embodiments can be provided to provide the following features, presented for illustrative purposes, and not by way of limitation: 1) a decanter/container concept and design; 2) a cooling system, water and ice in canister, insertion of cooling chamber to hold refill canister (system keeps the refill cold and enables servers to simply replace refill when empty and the system keeps cold for hours without adding more ice or water); 3) a mouthpiece, one way flow to prevent backwash; 4) refill canisters; 5) an entire system functioning as a single unit—canister, cooling chamber, refill canister, hoses, pumps, mouthpieces; and 6) a valve/pump flow system that can create flow and hold liquid in pump/reservoir. FIGS. 6-24 illustrate some examples of such embodiments. It should be noted, however that the embodiments of FIGS. 6-24 are presented by way of illustration and not by way of limitation. Additional, fewer, and/or alternative embodiments and/or components can also be employed without departing from the principles of the present invention.

We continue now with the description of preferred embodiments as illustrated in FIG. 6 through FIG. 24. FIG. 6 illustrates an exploded view of various components of a beverage dispensing system embodiment consistent with the present invention. In particular, FIG. 6 illustrates system 600 including a container embodiment 602, a cooling and/or heating chamber embodiment 604, a canister 606 storing potable liquid and having a sealing lid 608. Also illustrated is an embodiment of an inner tube assembly 610, to remove liquid from the bottom of canister 606, and a hose lid 612. The hose lid 612 constitutes part of a beverage delivery assembly 614, along with at least one hose 616, pump 618, and mouthpiece 619. Similar reference numerals in subsequent figures are meant to depict similar (although possibly alternative) embodiments to those components depicted as the numbered components illustrated in FIG. 6. Of course, those skilled in the relevant art will fully appreciate that more, less, or alternative component embodiments could also be employed without departing from the scope of the present invention.

The directional arrows in FIG. 6 depict an order of assembly for placing the system in use. For example, behind the scenes, relative to the consumer, (e.g., preferably handled by the venue service staff), the system 600 can be easy assembled by adding ice & water to container 602 (if a cold beverage is to be enjoyed); sliding the cooling chamber 604 into place; inserting canister 606 with the potable liquid (e.g., water, tea, coffee, alcoholic or non-alcoholic beverage, etc.); removing sealing lid 608; connecting the hose lid 612 (with the inner tube assembly 610 already positioned in canister 606; and then connecting the hose 616, pump 618, and mouthpiece 619 portions of the beverage dispenser assembly 614. Assembled system 600 can then be delivered to a table ready to be experienced by the consumers.

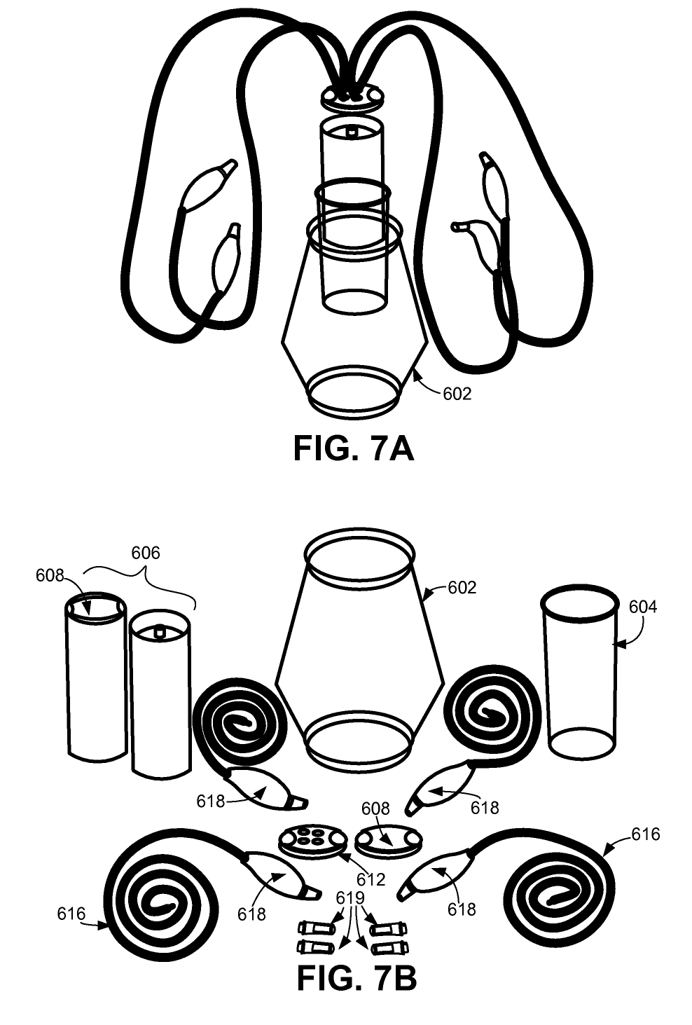

FIGS. 7A & 7B illustrate another alternative embodiment of a system, such as the system embodiment of FIG. 6, illustrated in partially assembled and disassembled views respectively.

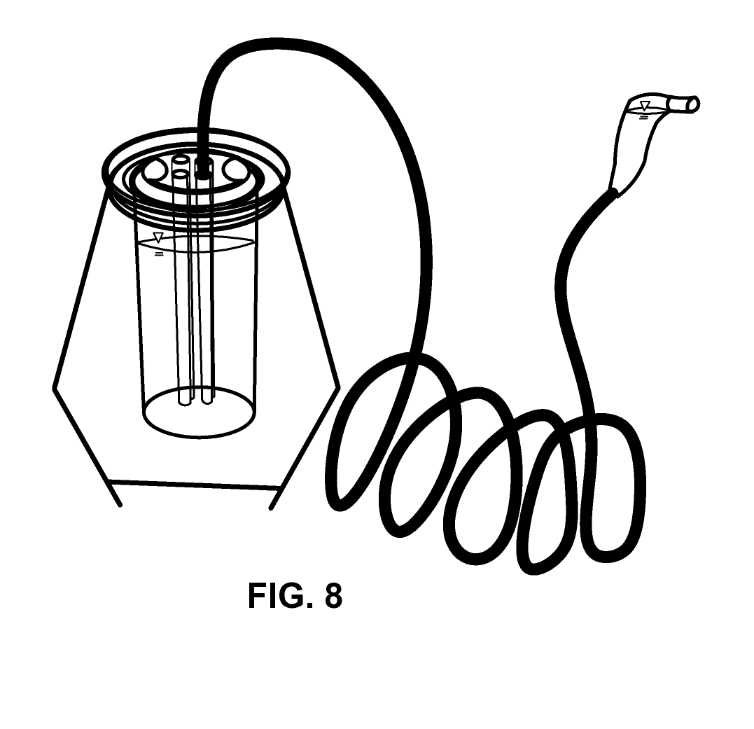

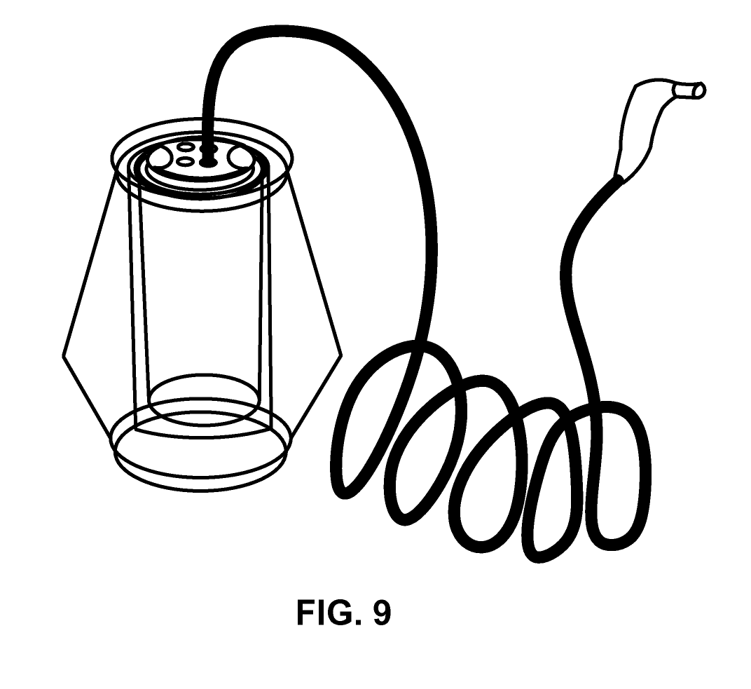

FIG. 8 illustrates a cutaway view of a partially assembled the system of FIG. 7A, illustrated with one hose embodiment and FIG. 9 presents the uncut system embodiment of FIG. 8. As depicted in FIGS. 8 & 9, an integrated gasket and connector design can help insure leak-proof transition of liquid to hose. An ergonomic pump design can be employed so that the pump is intuitive and comfortable to use. A flexible hose can be provided with a slightly resiliently biased, coiled central section so that it remains compact during normal use to prevent tangling and extends to a desired predetermined length (e.g., such as 60″) when needed. Embodiments of the canister can be manufactured to hold varying liquid capacities, such as 1.75 liter (˜60 fl. oz) or 750 ml, to name but two non-limiting examples. This exclusive design of systems consistent with the present application helps improve the consumer experience by providing a desired amount of liquid to enjoy at the preferred temperature. Materials can also be selected (such as using aluminum canisters) to promote/facilitate recycling, and reduce waste in order to support environmentally friendly values.

After a typical initial assembly, 2-3 squeezes of the pump is typically sufficient to draw liquid through the hose and fills the reservoir of the pump. The exclusive system employs one or more one-way valves to allow for automatic refilling of the reservoir after each pump/drink.

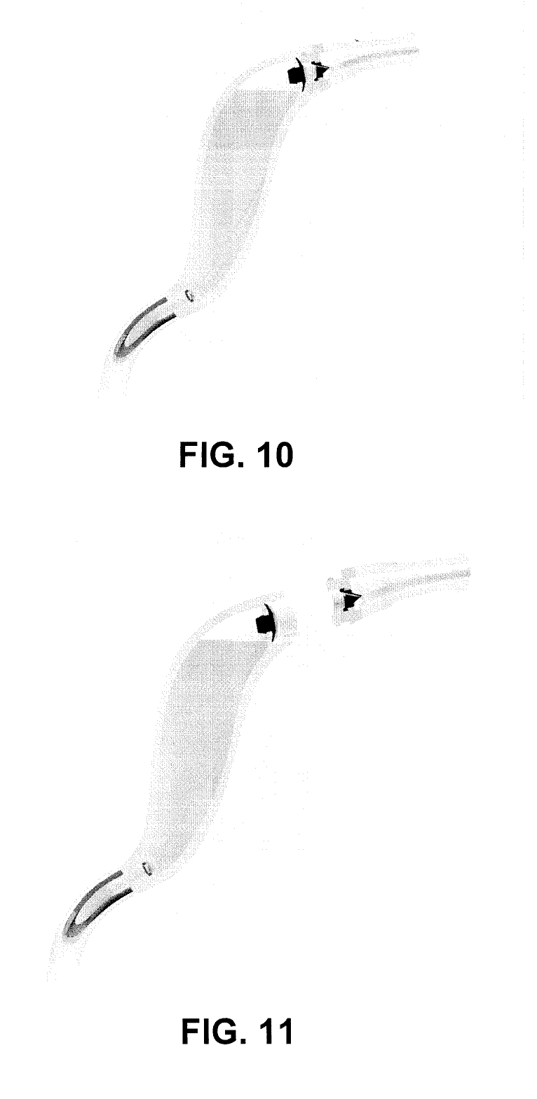

FIG. 10 illustrates a cutaway view of a pump assembly embodiment consistent the present application. Similarly, FIG. 11 illustrates the cutaway pump assembly embodiment of FIG. 10 with a removable mouthpiece embodiment removed. Preferably, the pump has a capacity of 45 ml-1.5 fl. oz. Of course, those skilled in the art will readily appreciate that other volumes could also be provided without departing from the principles of the present invention.

The pump system allows the consumer personally to regulate the liquid flow, from a gradual sip to a full shot. The user has complete control over their experience. The personal mouthpiece can be made to be removable and recyclable/cleanable and/or disposable. The mouthpiece can attaches and detaches with a simple ¼ turn using a tab/slot or bayonet style mechanism.

Employing one or more one-way valves in the pump and/or mouthpiece assemblies helps eliminate the possibility of backwash or other contaminates from passing through the individual mouthpiece into the reservoir and shared system. Additionally, an umbrella valve can be employed at the mouthpiece end of the pump so as to reduce or prevent spillage during mouthpiece attachment and removal.

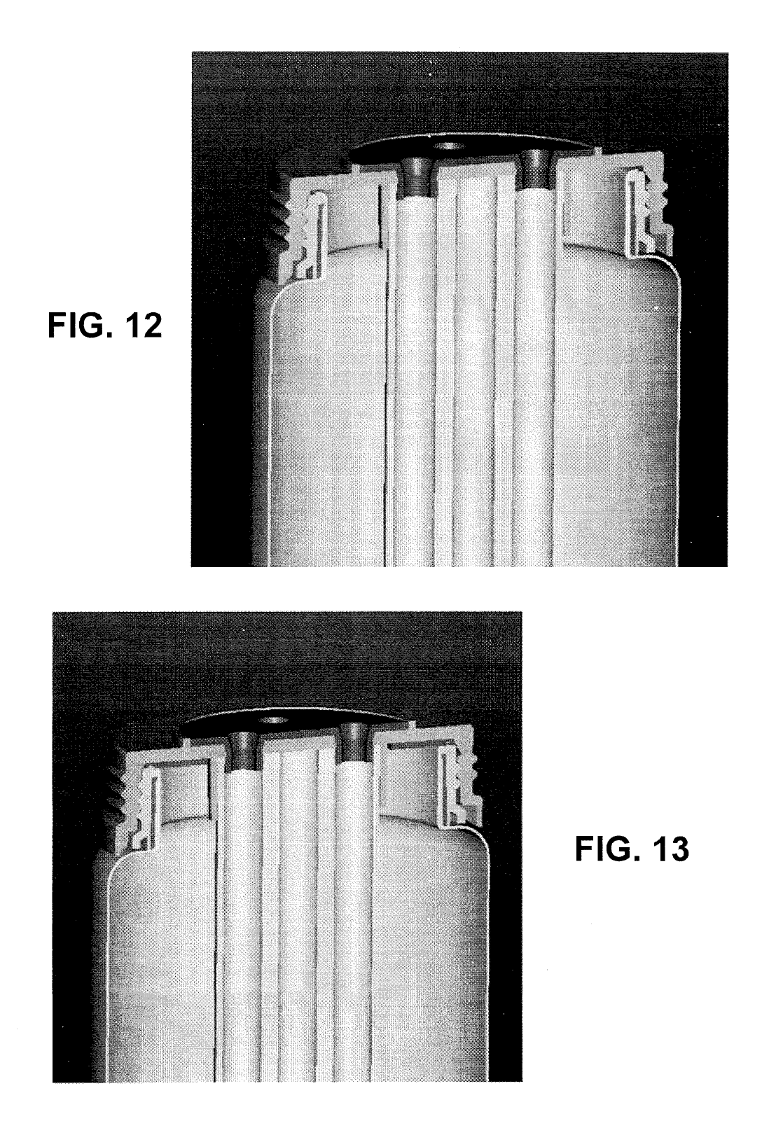

FIGS. 12-14 present cutaway views illustrating alternative embodiments of lids for canisters consistent with the present application. Canister and sealing lid parts can engage and lock together securely. Once in place, the canister can remain in an assembled configuration and make reopening of the assembly difficult, if it is preferred to use replacement canisters, rather than refillable canisters. The components pictured in FIG. 12 can be assembled without a cork or other compression/sealing element disposed between the replacement canister and lid (as pictured in FIG. 13), which can allow a bit of slack between the two components, if desired. The illustration of FIG. 13 shows how a thin layer of cork, rubber gasket, and/or other compressed material can be disposed between the canister and lid to help provide an improved waterproof and/or air-tight seal.

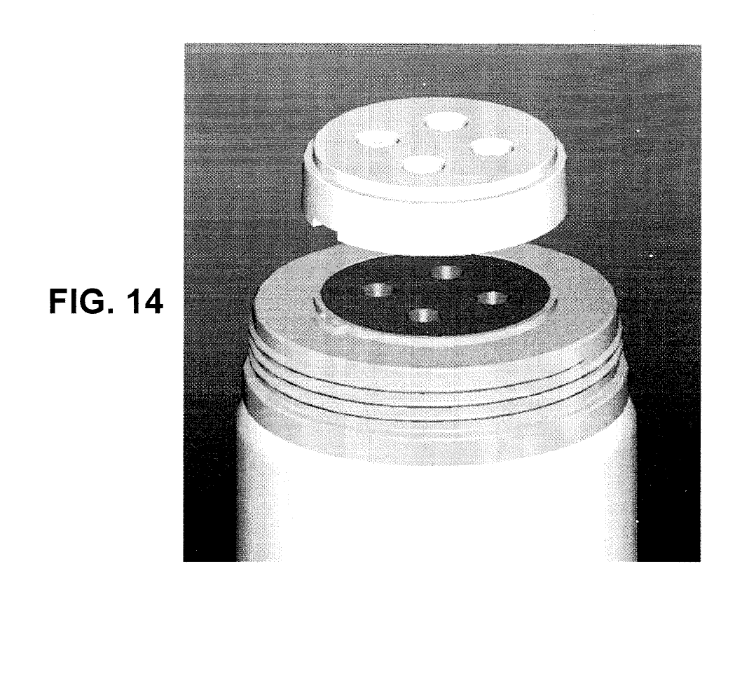

As illustrated in FIG. 14, a small registration feature can be provided in the design to facilitate one or more lids properly aligning and registering with so that hose holes line up with the holes for inner tubes in the canister.

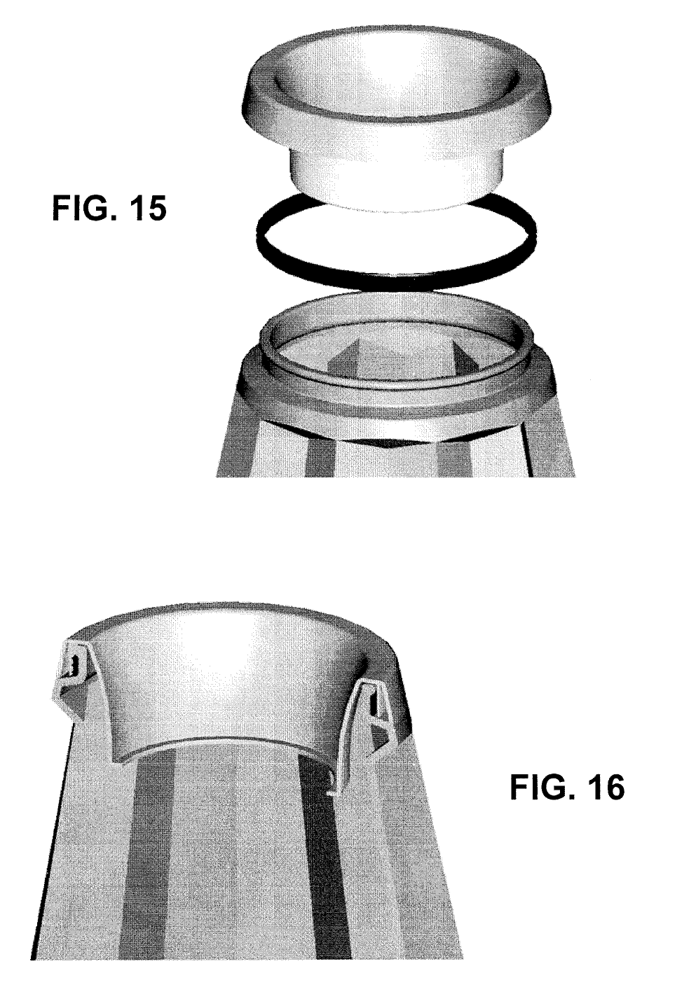

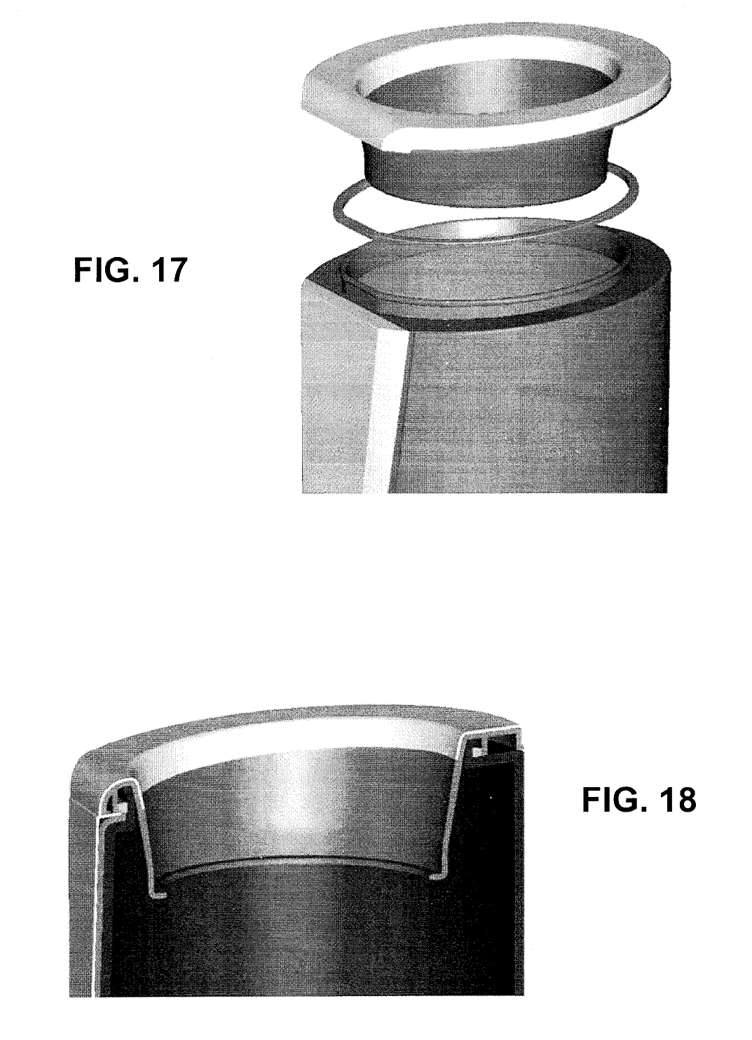

FIGS. 15 & 16 illustrate a portion of one embodiment of a container consistent with the present invention, shown in exploded and cutaway views respectively. FIGS. 17 & 18 illustrate a portion of another embodiment of a container consistent with the present invention, shown in exploded and cutaway views respectively. A decanter-style (or other style) container can be made of glass, plastic, ceramic, metal, and/or other suitable material, and can be constructed to exhibit substantially only external features around the neck area to facilitate manufacturing. A simple rubber gasket and internal wall within the funnel neck can provide friction to prevent buoyancy of the canister as the potable liquid is removed.

As illustrated in FIGS. 17 and 18, a second, alternative embodiment of a container can similarly be constructed with substantially only external features around the neck area. As before, the such an embodiment, a simple rubber gasket and internal wall within the funnel neck can also provide friction to prevent buoyancy.

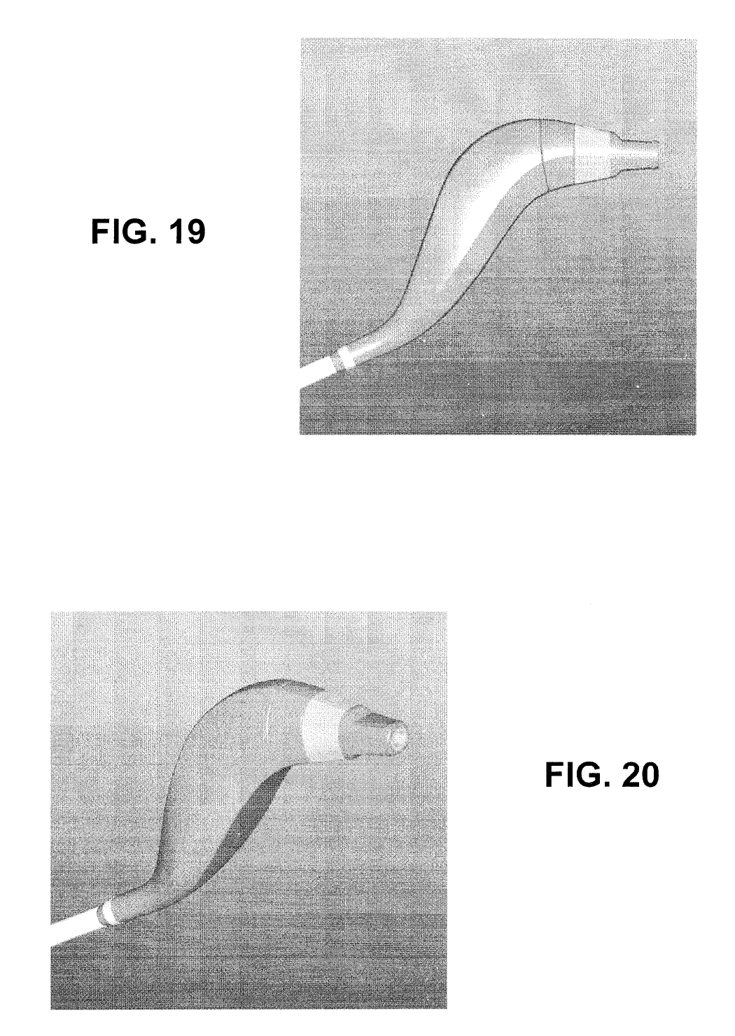

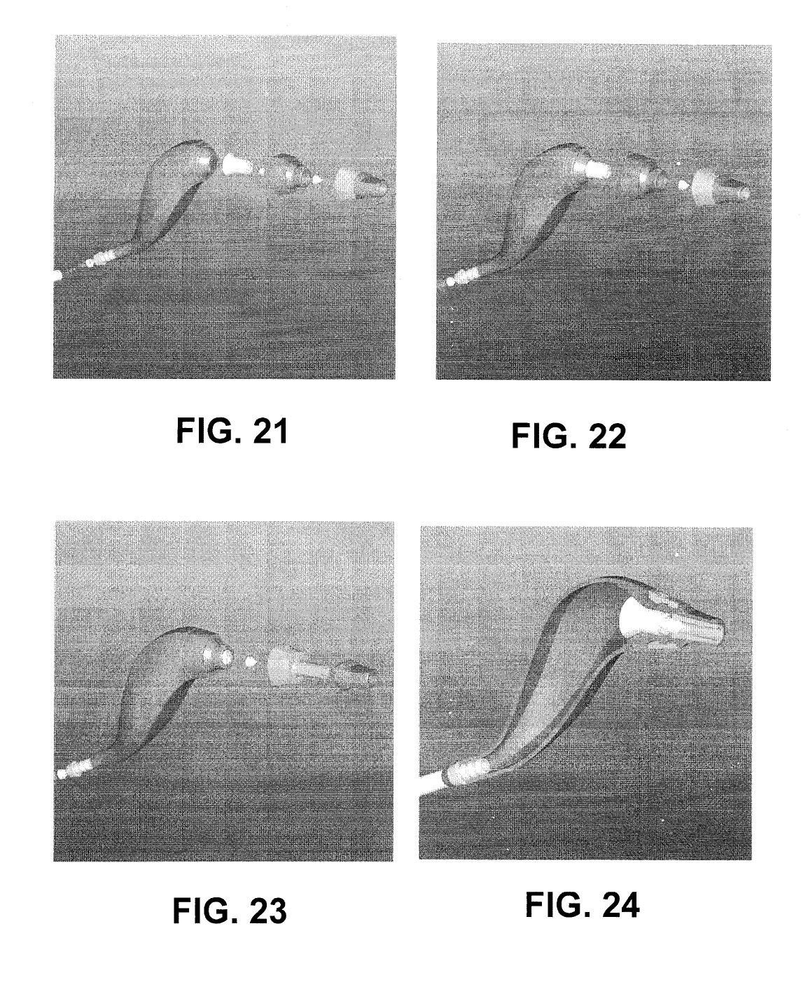

FIGS. 19 & 20 illustrate alternative a pump assembly embodiment in side and perspective view respectively. FIGS. 21-23 illustrate the pump assembly embodiment of FIGS. 19 & 20 in various exploded view configurations. Additionally, FIG. 24 illustrates the pump assembly embodiment of FIGS. 19 & 20 in an assembled, cut-away view.

One embodiment of a pump assembly can incorporate sufficiently firm/resilient plastic parts in both the pump and mouthpiece sub-assemblies to facilitate a proper substantially leak-free and substantially air-tight interlock. The overall diameter of the geometry at the mouthpiece end of the pump dispenser can be sized, proportioned, and/or configured in order to accommodate any additional material thicknesses involved in manufacturing, resulting from the selection of preferred materials. The resulting geometry can still exhibit intended design elements and without compromising the form factor.

As illustrated in FIGS. 21-24, one embodiment of a pump sub-assembly can consist of (by way of illustration and not by way of limitation) a bulb pump, a hard plastic internal screw neck, and a threaded cap. Similarly, as illustrated in FIGS. 21-24, a screw neck can employ a funnel-shaped end that can be inserted through a flexible open mouth of the pump. The hard plastic cap can be threaded tightly onto it, capturing the bulb pump and making a tight seal in the process. A valve, such as an umbrella valve as illustrated above, can be provisioned in the top surface of the screw component. The selection of a suitable umbrella valve can be fine-tuned during manufacturing and such a valve can be sized and manufactured of suitable material so as to achieve desired pressure and performance characteristics of operation in the manufactured system's intended environment.

One embodiment of a mouthpiece sub-assembly, as illustrated in FIGS. 21-24, can consist of a substantially resilient/firm plastic (or other suitable material) substrate along with an elastomeric bite grip over-mold providing a “soft” feel, if desired. The substrate can also be molded in different colors for differentiating between mouthpieces of multiple users of the system. A valve, such as the duckbill valve illustrated above, can be inserted into the mouthpiece sub-assembly and captured between its two components. Finally, FIG. 24 illustrates a cut-away view of the entire assembly, showing the internal layout and construction of the previously described and illustrated embodiment.

It will be obvious to those having skill in the art that many changes may be made to the details of the above-described embodiments without departing from the underlying principles of the invention. The scope of the present invention should, therefore, be determined only by the following claims.

1. A system for dispensing a potable liquid to one or more consumers, the system comprising:
a container having an aperture;
a canister containing a potable liquid and configured for insertion via the aperture so as to be positioned at least partially within the container; and
one or more hoses for conveying the potable liquid to a corresponding one or more consumers;
wherein:
each of the one or more hoses is fitted with a pump for inducing controlled unidirectional flow of the potable liquid through the corresponding hose; and
each pump is in fluid communication with a mouthpiece provisioned for delivering the potable liquid to the corresponding consumer.

2. The system of claim 1, wherein the container contains a substance selected for influencing temperature of the potable liquid in the canister.

3. The system of claim 2, wherein:
the selected substance is ice water, if the beverage is preferably consumed at a cooler than ambient temperature; and
the selected substance is heated water, if the beverage is preferably consumed at a warmer than ambient temperature.

4. The system of claim 1, wherein the mouthpiece is configured for provisioning in a mouth of a corresponding consumer.

5. The system of claim 4, wherein the mouthpiece includes a bite grip for facilitating a comfortable connection with the mouth of the corresponding consumer.

6. The system of claim 1, wherein each pump has an internal reservoir having a volume.

7. The system of claim 6, wherein each pump includes one or more one-way valves so as to facilitate unidirectional flow.

8. The system of claim 6, wherein each pump is a mechanical bulb hand pump and includes a first one-way valve at a hose end and a second one-way valve at a mouthpiece end, the first one-way valve and second one-way valve provisioned so that constricting the pump reduces the volume and expels the contents of the internal reservoir through the mouthpiece, and releasing the pump draws the potable liquid through the hose into the internal reservoir.

9. The system of claim 1, further comprising a cooling chamber provisioned within the container for securely receiving the canister.

10. The system of claim 1 further comprising a canister lid coupled with the one or more hoses and configured for securely engaging the canister so as to facilitate the potable liquid being transmitted through the one or more hoses.

11. The system of claim 10, wherein the canister includes at least one internal tube for transmitting the potable liquid to the one or more hoses from a bottom portion of the canister.

12. A method for dispensing potable liquid to a group of consumers, the method comprising:
providing a container having a substance for regulating temperature;
provisioning within the container a canister containing a potable liquid;
attaching to the canister a dispenser assembly providing each consumer of a group of consumers with a pump to transfer controlled amounts of the potable liquid through a mouthpiece for consumption

13. The method of claim 12, further comprising:
upon the canister becoming emptied:
detaching the dispenser assembly from the canister;
removing the canister from the cooling chamber;
inserting a second canister into the cooling chamber; and
attaching the beverage dispenser to the second canister.

14. An apparatus, comprising:
a hose in fluid communication with a pre-filled source of potable liquid;
a mouthpiece for delivering the potable liquid to a consumer; and
a pump assembly having in internal reservoir and being configured for establishing unidirectional flow of the potable liquid through the hose, into the internal reservoir, and out to the consumer through the mouthpiece.

15. The apparatus of claim 14, wherein the pump is a hand-held mechanical pump.

16. The apparatus of claim 15, wherein the pump includes a one-way valve.
